(19) United States
(12) Patent Application Publication
(10) Pub. No.: US 2012/0231310 A1
(43) Pub. Date: Sep. 13, 2012

(54) PROFILE STRIP FOR AN ELECTROCHEMICAL ENERGY STORAGE DEVICE

(75) Inventors: Walter Lachenmeier, Sankt Augustin (DE); Andreas Gutsch, Luedinghausen (DE); Claus-Rupert Hohenthanner, Hanau (DE); Claudia Brasse, Meerbusch (DE)

(73) Assignee: Li-Tec Battery GmbH, Kamenz (DE)

(21) Appl. No.: 13/497,925

(22) PCT Filed: Aug. 30, 2010
(86) PCT No.: PCT/EP2010/005320

§ 371 Date: May 23, 2012

(30) Foreign Application Priority Data
Sep. 25, 2009 (DE) 10 2009 043 127.6

(51) Int. Cl. H01M 2/10; H01R 43/00

(52) U.S. Cl. 429/99; 429/100; 429/96; 29/825

(57) ABSTRACT

A profile strip to border an electrochemical energy storage device having at least one, essentially, longitudinally extending first recess, which is bordered by a first arm and a second arm. The first and the second arm are made such that they are attachable to opposite sides of an boundary area of the electrochemical energy storage device, and at least partially connected to each other with a backside part. In a method of producing such a profile strip for an electrochemical energy storage device, at least one first recess is inserted into the profile strip by a suitable method, and the profile strip is converted in said first recess from a first, stretched, state into a second, angled, state. The corner resulting from bending may have a connection by force-fit or by material engagement.

### DESCRIPTION

The present invention relates to a profile strip, an electrochemical energy storage device having said profile strip, a battery having said electrochemical energy storage devices, and a method of producing said profile strip.

The invention is described in the context of lithium-ion batteries to power motor drives. However, it is pointed out, that the invention may also be used irregardless of the type of battery or irregardless of the type of the powered drive.

An electrochemical energy storage device comprises reactive substances, a safe way of operation is therefore, only possible, when uncontrolled reactions of said reactive substances, for example, with the environment, are prevented.

The jacket of an electrochemical energy storage device separates the reactive substances, which are within the jacket, from the environment surrounding the jacket. So, the jacket prevents that substances escape from or enter the electrochemical energy storage device uncontrolled. Thus, on the one hand, the jacket supports the safe operation of the electrochemical energy storage device and on the other hand, the environment is protected from contaminations by substances from the electrochemical energy storage device. A particularly vulnerable area of the jacket is its boundary area.

By a device, which at least reduces external stresses on said vulnerable area of the jacket, the safety of an electrochemical energy storage device can thus, be improved.

Batteries with several electrochemical energy storage devices for motor drives are known. Some types of batteries have in common, that the environment of said batteries is at risk, after failure of an electrochemical energy storage device due to the escape of the cell contents.

The underlying object of the present invention is therefore, to increase the safety of the electrochemical energy storage device.

According to the invention, this is achieved by the teachings of the independent claims. Preferred embodiments of the invention are the subject-matter of the dependend claims.

The profile strip according to the invention preferably serves to protect the border of an electrochemical energy storage device. The profile strip has at least one first slit, which is extending, essentially, longitudinally. Said slit is limited by a first arm and by a second arm. Said first arm and said second arm are designed such that they may be attached to opposite sides of a boundary area of the electrochemical energy storage device.

An electrochemical energy storage device according to the invention has at least an electrode stack, a conductor, wherein said conductor is electrically connected to the electrode stack, a cover of a thin-walled composite material, which surrounds the electrode stack at least partially, and which has in its boundary area at least one border. A profile strip according to the invention covers at least one area of said jacket of this electrochemical energy storage device.

A battery according to the invention has at least two electrochemical energy storage devices. Said electrochemical energy storage devices are preferably, essentially, arranged in parallel to each other and have profile strips according to the invention in the boundary area of their covers. Said profile strips according to the invention are designed such that the covers of the energy storage devices exert, essentially, no forces onto each other. The electrochemical energy storage devices are provided to be electrically connected to each other.

According to the invention, a method of producing a profile strip for electrochemical energy storage device is characterized by different manufacturing steps. In the profile strip according to the invention, at least one first recess is introduced by a suitable method. The shape of said first recess has, preferably, an, essentially, triangular design. Said first recess is provided to bend the profile strip according to the invention. By bending the profile strip according to the invention, it is converted from a first, stretched, state into a second, angled, state. The process of bending is exerted such that the tensile strength of the profile strip according to the invention is not exceeded.

The electrochemical energy storage device according to the invention has at least one profile strip. A profile strip according to the invention is, preferably, an essentially, thin-walled body, which is, preferably, made of an electrically insulating material or of a material, which is at least coated with an electrically insulating layer. Said profile strip has at least one defined cross-sectional area in one or, in several areas.

Said cross-sectional area has in a preferred embodiment, a first arm, a second arm and a backside part. Preferably, said backside part connects said first arm with said second arm.

Said first arm, preferably, is, essentially, opposed to said second arm. Both arms border a first slit. Said first arm preferably forms an essentially, U-shaped, thin-walled body with said second arm and said backside part.

In one preferred embodiment, the profile strip has only one component. In another embodiment, the profile strip is made of several components, preferably of a first arm, a second arm, and a backside part. Preferably, said components are connected to each other by positive fit or by material engagement. By means of a one-piece design of the profile strip, a particularly simple and reliable mounting of the profile strip to the jacket is achieved.

In case, the profile strip is provided to cover a portion of the boundary area of the jacket, characterized by corners or radii, then, also the profile strip will be, preferably, designed in a shape, adjusted to said boundary area. Therefore, the profile strip will be made either in a shape, which is at least partially adjusted to said portion of the boundary area, or the profile strip will be converted from a first, stretched, state into a second, one time or several times angled, state. To be able to bend the profile strip in said described form, said profile strip will be provided with one or more first recess(es). By this shaping, the profile strip may at least partially cover the boundary area of the jacket, which is characterized by corners and radii.

A first recess refers to a material-free space of the profile strip, which, starting at the first recess, extends towards the direction to the backside part. In a preferred embodiment, said first recess has an, essentially, triangular shape. Such a first recess is generally known from window or picture frames and refers to a miter cut.

In its second state, the profile strip has at least one break. Viewed in the longitudinal direction before and after said break, the profile strip runs at least partially linearly.

An electrochemical energy storage device has at least one electrode stack, one conductor, a jacket, and a profile strip.

An electrode stack refers to an arrangement with at least two electrodes and an electrolyte, which is arranged between two electrodes, respectively. An electrode stack serves for the storage of chemical energy and for its conversion into electrical energy. Conversely, the electrode stack may serve for converting electrical energy into chemical energy, in the case of a rechargeable battery.

Presently, a jacket refers to a device, which also prevents the escape of chemicals from the electrode stack into the environment. Furthermore, the jacket preferably protects the chemical constituents of the electrode stack from unwanted interaction with the environment. For example, the jacket protects the electrode stack from the entrance of water or of water vapor from the environment. Preferably, the jacket is made in a film-like manner. Preferably, the jacket should influence the passage of heat energy as little as possible. Presently, the jacket has one or more shaped parts, preferably two shaped parts. Preferably, the jacket is at least partially adapted to the shape of the electrode stack and encloses said electrode stack.

Here, “to surround” means, that one or more shaped part(s) of the jacket, may be partially in contact to a second shaped part or to itself/themselves. This way, the electrode stack is placed between the involved surface areas of the shaped parts. Said one or more shaped part(s) touch(es) each other partially, laminarly, preferably, at least along an boundary area, which borders the jacket or, respectively, along a border of one or more shaped parts, involved.

According to the invention, a border refers to the direct boundary area of the jacket. The border runs around the jacket. Preferably, the conductors are guided from the interior of the jacket through the border of the electrode stack to the outside.

According to the invention, a “conductor” refers to a device, which, essentially, allows the flow of electrons between an electrode and an electrical load. A conductor is electrically connected to an electrode or, respectively, to an active electrode mass of the electrode stack and further connected to a cable connection. The shape of the conductor is adapted to the shape of the electrochemical energy storage device or, respectively, of the electrode stack. Preferably a conductor has a sheet-like or film-like shape. Preferably, each electrode of the electrode stack has its own conductor or, respectively, the electrodes of the same polarity are connected to a common conductor.

The profile strip is preferably mounted to the jacket in the area of the border. Thus, the profile strip covers an area of the jacket, in which the surface areas of one or more of said shaped part(s) touch each other. External stresses act therefore, no longer directly onto said border, but onto the profile strip. By means of the profile strip, the boundary area of the jacket is at least partially relieved.

In the transition area from the profile strip to the jacket, the profile strip has preferably, at least a chamfered or a rounded edge. By this design of said edge, the contact stresses, which are induced in the jacket by the profile strip, are reduced with respect to design with a sharp edge. By reducing the contact stresses in the jacket, an increase in safety against an uncontrolled leackage of substances from the jacket, as well as against an uncontrolled entrance of substances into the jacket, is achieved.

In a particularly preferred embodiment, the profile strip has an, essentially, U-shaped cross-section and covers the entire border of the jacket. Substances which leak from the jacket in the area of the border, first end up in the profile strip, and thus, may not directly act reciprocally with the environment. Hence, the safety of the electrochemical energy storage device is further increased.

In a preferred embodiment, the profiled strip is provided with an, essentially, U-shaped cross-section. This cross-section is, preferably, designed such that the distance between two arms, which oppose each other at least partially, is less than the thickness of the jacket in the area of the border. The areas of the U-shaped profile strips with the at least partially opposite first and second arms, exert thus, a normal force on the surface area of the jacket in the area of the border. The normal force is, essentially, directed such that it presses two surface areas of the jacket, close to the border, at least partially together. Due to this normal force, and additional rigidity may be achieved and thus, the safety of the electrochemical energy storage device may be increased.

In a preferred embodiment, the profile strip is connected to the jacket by material engagement. The term “material engagement” refers, preferably, to the gluing or the welding of the jacket to the profile strip. By means of a material engagement between the jacket and the profile strip, the safety of the electrochemical energy storage device is further increased. The connection by material engagement of the profile strip to the jacket prevents, that the profile strip is removed partially or completely from the jacket by means of low mechanical stress. Due to the secure mounting of the profile strip to the jacket, the effect of the profile strip is maintained during the entire lifetime of the electrochemical energy storage device.

In a preferred embodiment, the profile strip has a second recess. The second recess is provided to feed through a conductor. In a particularly preferred embodiment, the shape and the number of the second recesses is, essentially, equal to the shape and number of the conductor. To increase the safety of the electrochemical energy storage device in a preferred embodiment, one or more conductors are fed through one or more second recess(es). Preferably one conductor is fed through a second recess, respectively. In the area of the second recess, a conductor is connected to the profile strip by force-fit, by positive fit, or by material engagement.

The external forces acting on the conductor, are at least partially absorbed by the the profile strip. By this force deflection, the area in which the conductor protrudes through the jacket is mechanically relieved. Similarly, the area in which the conductor is connected to the electrode stack is also relieved. By relieving these areas of connection, the safety of the electrochemical energy storage device is increased.

A battery according to the invention is to be understood as a device with two or more electrochemical energy storage devices. The number of its electrochemical energy storage devices, and the type of its electrical wiring within a battery, depends on the requirements that are imposed on the battery. The electrochemical energy storage devices, contained in such a battery are, preferably, equipped with profile strips according to the invention. In particular, the safety of the energy storage devices is increased by said profile strips.

The cross-sectional area of the profiled strip is preferably configured such that at least the jacket of two electrochemical energy storage devices, which are arranged, essentially, in parallel to each other, do not directly exert any forces on each other. By exerting a force on the jacket, the pressure within the electrochemical energy storage device rises. Thus, the jacket is stressed by a force applied to said cover, and by the pressure caused in said jacket. The reduction of an external force application on the jacket by means of a profile strip, results therefore, into an increase in safety of the electrochemical energy storage device.

The cross-sectional area of the profile strip is, preferably, designed such that two energy storage devices, which are arranged, essentially, in parallel to each other, may be connected by means of their profile strips by positive fit, by force-fit and/or by material engagement. The profile strips of two adjacent electrochemical energy storage devices form, preferably, a common connecting area. In said connecting area, two adjacent profile strips are connected to each other, at least partially by material engagement, or, preferably, by force-fit, or, particularly preferably, by positive fit. Through this type of connection, at least two electrochemical energy storage devices form in a simple manner a structural unit. The simple structure of such a mechanical unit contributes to an increase in the safety of the electrochemical energy storage device.

Preferably, the cross-sectional area of a profile strip is designed such that two electrochemical energy storage devices, which are arranged, essentially, in parallel to each other, may be connected to a structural unit by means of a connecting element. Preferably, a connecting element with at least one profile strip form a connecting area. Preferably, the connecting element is connected to the profile strip in said connecting area at least partially by material engagement, or, preprefably, by force-fit or, particularly preferably, by positive fit. Between two electrochemical energy storage devices, preferably, a separating element is positioned. The separating element contacts, preferably, the jacket at least of one electrochemical energy storage device. The connecting element is connected to the separating element, preferably, by material engagement or, preferably, by positive fit or, particularly preferably, by force-fit. Preferably, a heat conduction from the jacket of the electrochemical energy storage device to said connecting element, is achieved with this separating element. By improving the thermal management of the electrochemical energy storage device, the safety will be increased.

According to the invention, the term “method for producing a profile strip for an electrochemical energy storage device” refers to the implementation of a first recess into the profile strip, the bending of the profile strip, and, optionally, the connecting of the cut or machined surface areas of said first recess.

The shape of the first recess and the process of bending are, preferably, designed such that the tensile strength of the profile strip is not exceeded. For example, the profile strip may be heated for the later bending. This maintains the profile strip as a one-piece element. The one-piece design of the profile strip simplifies the handling of the profile strip when mounted to the jacket.

In a preferred embodiment of the method, after the bending of the profile strip, the resulting corner may, preferably, be connected by material engament by means of gluing or, particularly preferably, by welding. By this material engagement of one or more corner joint(s), the rigidity of the profile strip is increased. Externally applied stresses to the profile strip are thus absorbed more effectively by the profile strip and less strongly transferred to the jacket, compared to a profile strip, which has corner joints that are not connected by material engagment or by positive fit.

The connection by material engagement of one or, preferably, more corner joint(s), improves the sealing of the electrochemical energy storage device. The increased rigidity and the improved sealing of the profile strip due to the described method for producing, hence, increase the safety of the electrochemical energy storage device.

Thus, the emission of the contents of the electrochemical energy storage device according to the invention is prevented, and also the entrance of an undesirable substance into the electrochemical energy storage device is prevented, and consequently the underlying problem of the invention is solved.

Additional advantages and embodiments of the present invention are illustrated in the subsequent figures:

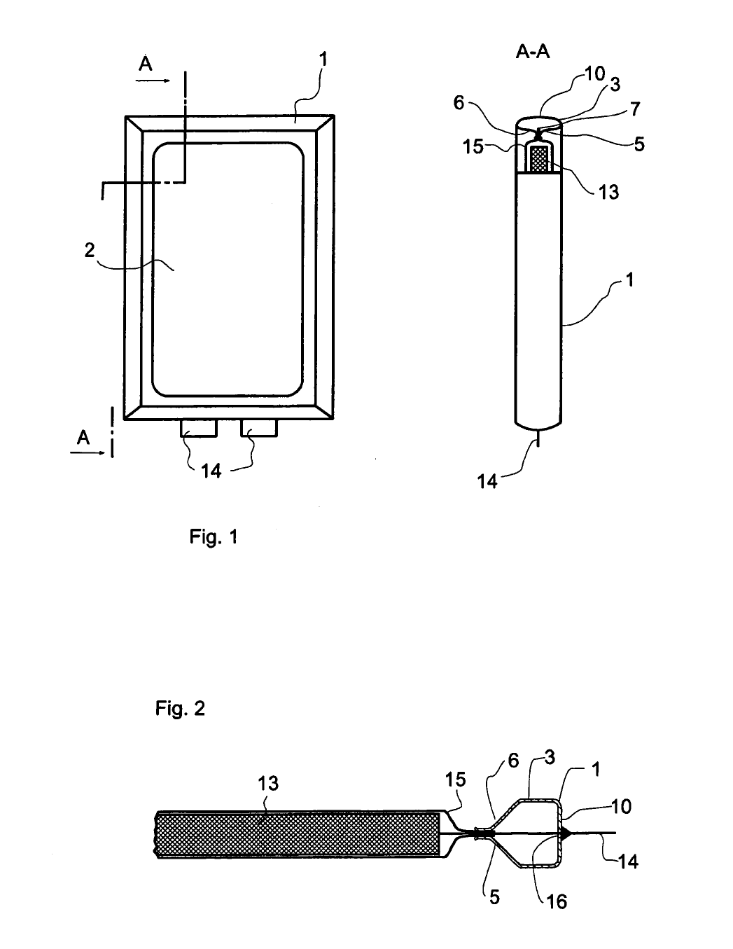

FIG. 1 shows an exemplary electrochemical energy storage device with a multiple bended profile strip, wherein the section A-A shows an exemplary cross-sectional area of a profile strip of the jacket of the electrode stack, and of the electrode stack;

FIG. 2 shows a conductor, exemplarily fed through the profile strip, as well as a connection by material engagement of the conductor with the profile strip;

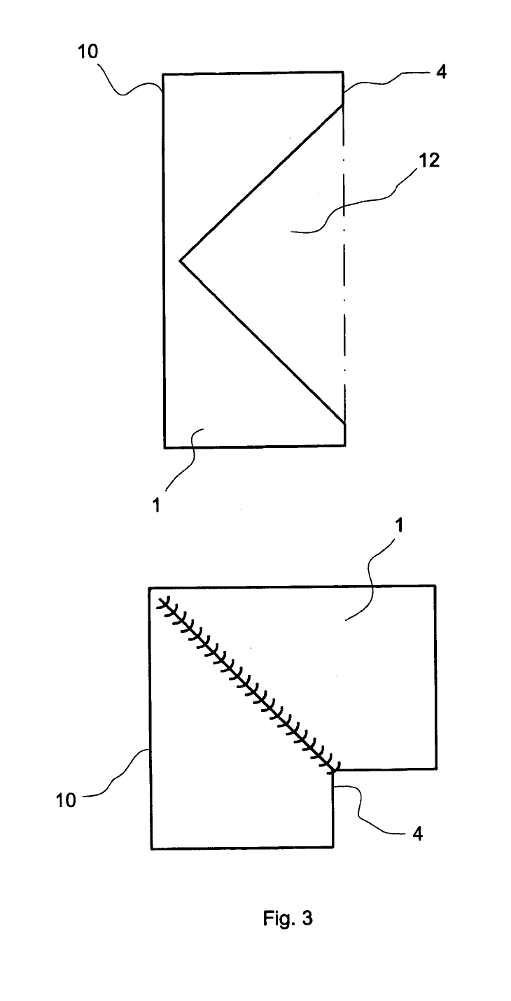

FIG. 3 shows an exemplary first recess in a straight profile strip and an angled profile strip with a corner connection by material engagement;

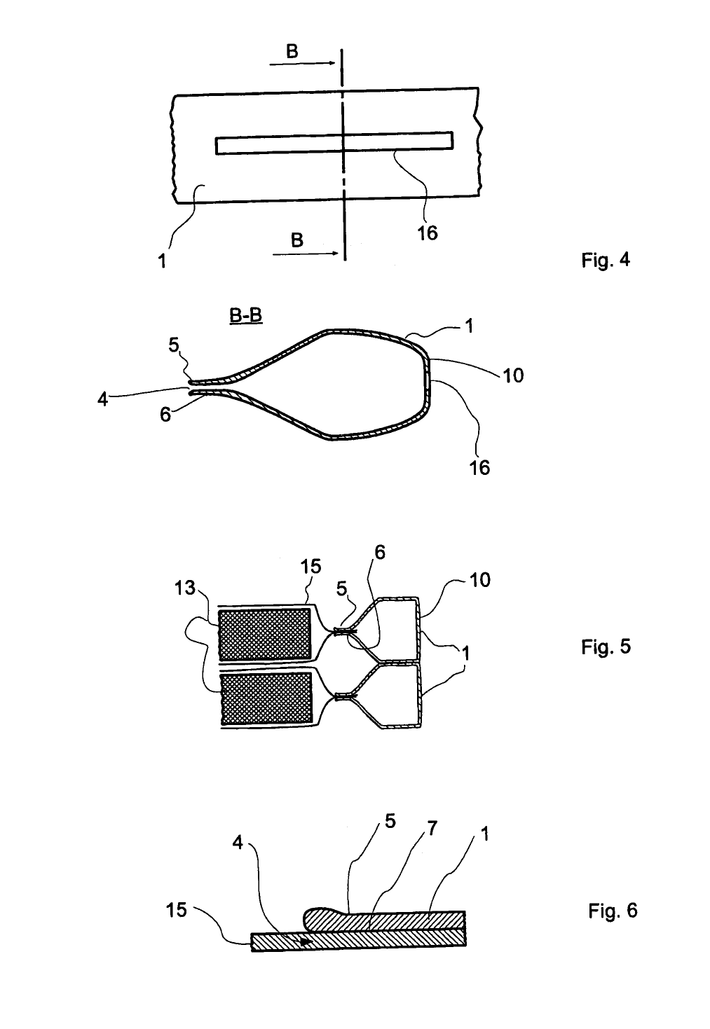

FIG. 4 shows an exemplary second recess in a profile strip and a section B-B, in which an exemplary cross-sectional area of the profile strip and the position of said second recess are shown;

FIG. 5 shows an exemplary battery, consisting of two electrochemical energy storage devices with profile strips according to the invention;

FIG. 6 shows a part of the jacket and an exemplary cross-sectional area of the jacket with a contact line, a connecting line, and a first open end;

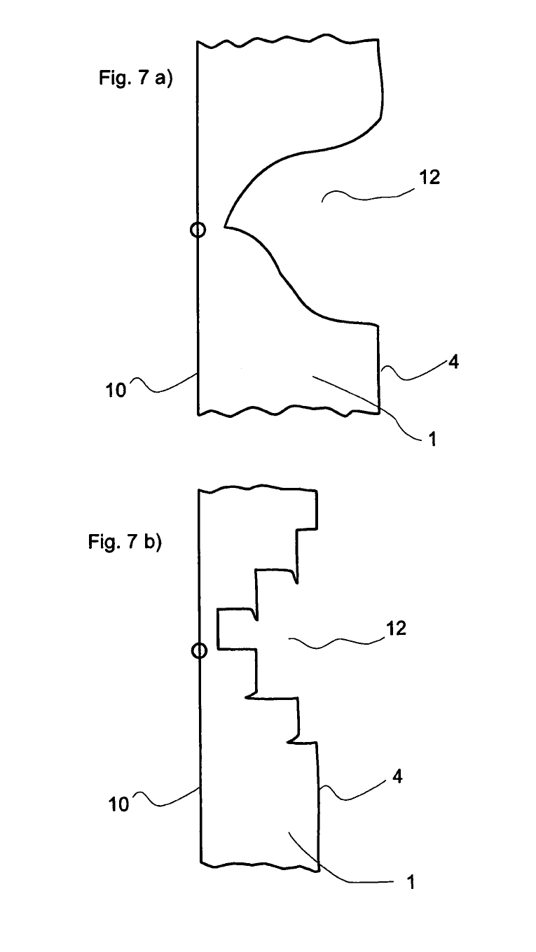

FIG. 7 shows in part a) an arc-shaped miter cut and in part b) a step-shaped miter cut, and

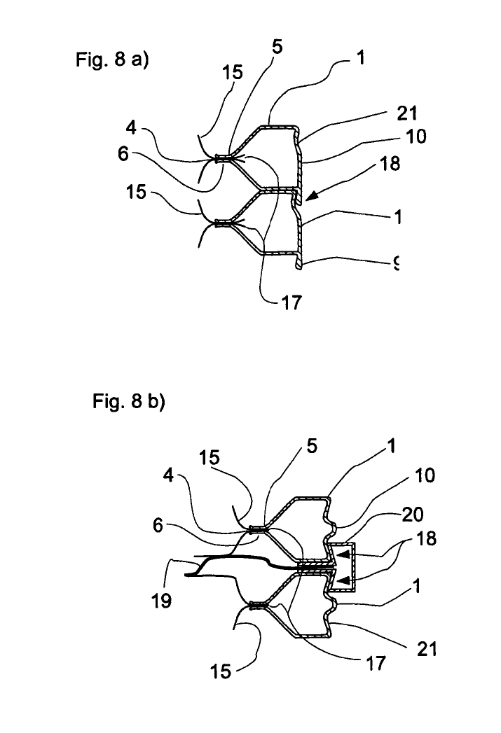

FIG. 8 shows in part a) two profile strips interconnected by positive fit and in part b) two profile strips, which are interconnected to each other by a connecting element.

First, the invention is illustrated in an example using FIG. 1 and FIG. 2.

FIG. 1 shows an electrochemical energy storage device 2, which is surrounded by a profile strip 1. For surrounding the electrochemical energy storage device 2, the profile strip 1 is converted from a first, stretched, state into a second, angled, state. FIG. 1 shows a multi-angled profile strip 1.

The profile strip 1, which is in said embodiment, essentially, U-shaped, is attached to the jacket 15 of the electrochemical energy storage device in the area of the border 17. The cross-sectional area 3 of the profile strip 1 has in said embodiment, a first arm 5 and a second arm 6, wherein said two arms are connected to each other by a backside part 10. The two arms are designed such that they exert a force onto the surface area of the jacket 15. The force exerted by the profile strip 1, causes the jacket 15 to be pressed together in the area of its border 17. The two arms of the profile strip 1 are designed such that the profile strip 1 has no sharp-angular edges in the area of contact with the jacket 15. Due to this design, the stresses, which are exerted through the two arms on the jacket 15, are kept low. The profile strip 1 is in the area of its first and its second arm 5, 6 partially connected by material engagement by gluing to the jacket 15.

At a predetermined area two second recesses 16 are implemented into the profile strip 1. A conductor 14 is fed through a second recess 16, respectively. In said embodiment the conductor 14 is connected to the profile strip 1 by material engagement. This connection is illustrated in FIG. 2. FIG. 4 shows a second recess 16 in a profile strip 1. The shape and the extent of the second recesses 16 is based on the shape and extent of the conductor 14, which is fed through said second recess. The shape of the second recess 16 is designed such that it is suitable for accepting a plate-shaped conductor 14 (not shown).

FIG. 3 shows a first recess 12 in a profile strip 1. The first recess 12 is provided to convert the profile strip 1 from a first, stretched, state into a second, angled, state. In general, such a recess is called a miter or a miter cut.

In the embodiment shown in FIG. 3, a straight miter cut is shown. In FIGS. 7a and 7b other possible embodiments for miter cuts are shown. In the embodiment of the miter cut shown in FIG. 7a, the available connecting area is enlarged. This is particularly advantageous for a connection by material engagement.

The miter cut shown in FIG. 7b is provided to form a positive fit miter connection. A corner of the profile strip 1 is connected to such a miter cut according to the female/male-principle.

The positive fit miter connection needs no additional connection by material engagement of the profile strip 1 with itself.

FIG. 5 shows a battery, which is composed of two electrochemical energy storage devices 2. The shape of the profile strips 1 is designed such that the covers 15 exert, essentially, no forces onto each other. The two electrochemical energy storage devices 2, are thus, directly in contact to each other along their profile strips 1.

FIG. 6 shows in detail the contact area of the profile strip 1 with the jacket 15. It can be seen that the first arm 5 has a rounded edge in the contact area with the jacket. This rounded edge serves to relieve the contact area between the profile strip 1 and the jacket 15.

FIG. 8a) shows a battery, wherein said battery consists of two electrochemical energy storage devices 2. These two electrochemical energy storage devices 2 are directly connected through their profile strips 1 by form fit. The cross-sectional area 3 of a profile strip 1 is designed such that two profile strips 1, are arranged, essentially, in parallel to each other, and that they form a connecting area 18. In the connecting area 18, a connecting projection 9 of a profile strip 1 engages in a first recess 21 of a further profile strip 1. Through the engagement of one of the profile strips 1 with the other profile strip 1, a positive fit connection is established. By this embodiment of the profile strip 1, the assembly of a block of several electrochemical energy storage devices 2 is in a simple way enabled.

FIG. 8b) shows a battery, wherein the battery consists of two electrochemical energy storage devices 2, a connecting element 20, and a separating element 19. The connecting element 20 forms with each of the two profile strips 1 a connecting area 18 and is thus, connected to them by positive fit. Two electrochemical energy storage devices 2 are thus, indirectly connected by positive fit through a connecting element 20 and the profile strips 1. The separating element 19 is used, among other things, for thermal conduction. For this the separating element 19 is contacting the jacket 15 of both electrochemical energy storage devices 2 and is connected to the connecting element 20 by force-fit. Through the separating element 19, temperature flows are conducted from at least one jacket 15, or supplied to a jacket 15. Thus, the temperature balance is by the separating element 19 mainly in the area between two electrochemical energy storage devices 2, improved. Through this embodiment of the profile strip 1 and the corresponding connecting element 20, the assembly of a block of several electrochemical energy storage devices 2 with improved temperature balance is in a simple way enabled.

1-15. (canceled)

16. A profile strip for providing a border in an electrochemical energy storage device, the profile strip comprising:
at least one first slit, which is extending essentially longitudinally, and which includes a border, a first arm and a second arm,
wherein the first and the second arms are made such, that they are attachable to opposite sides of a boundary area of the electrochemical energy storage device and are at least partially connected to each other with a backside part, and
wherein said profile strip includes at least one first recess, and said first recess is provided to convert said profile strip from a first, stretched, state into a second, angled, state.

17. The profile strip according to claim 16, wherein said profile strip is at least partially made of an electrically insulating plastic or is covered with said electrically insulating plastic, the electrically insulating plastic including at least one of polyvinyl chloride (PVC), polyethylene (PE), or polyurethane (PU).

18. Profile strip according to claim 16, wherein said profile strip is made of one piece.

19. The profile strip according to claim 16, wherein said profile strip comprises a first, stretched, state or a second, angled, state.

20. The profile strip according to claim 19, wherein said first recess of the profile strip, starts at the first slit and extends towards a backside part.

21. The profile strip according to claim 16, wherein said profile strip includes at least a second recess in its backside part to receive at least one conductor.

22. An electrochemical energy storage device, comprising:
one electrode stack;
one conductor, which is connected to the electrode stack in an electrically conductive manner; and
one cover of a thin-walled composite material, which at least partially surrounds the electrode stack, and which includes, at its border portion, at least one border,
wherein a profile strip covers a portion of the cover according to claim 1 and is at least partially connected to said cover by material engagement or by force-fit.

23. The electrochemical energy storage device according to claim 22, wherein said profile strip is made such that it exerts a normal force onto the cover.

24. The electrochemical energy storage device according to claim 22, wherein at least one conductor is connected to the profile strip by force-fit, by form-fit, and/or by material engagement.

25. A battery with at least two electrochemical energy storage devices according to at least one of the claim 22, wherein
the energy storage devices has profile strips, such that covers of the energy storage devices exert no forces onto each other, and
profile strips of two adjacent electrochemical energy storage devices are connectable with each other by form-fit, by force-fit, and/or by material engagement without any additional components.

26. The battery having at least two electrochemical energy storage devices according to at least one of the claims 22, wherein
two profile strips of two adjacent electrochemical energy storage devices are connectable to each other by a connecting element and by form-fit, by force-fit, and/or by material engagement, and
a separation element is arranged between two electrochemical energy storage devices.

27. A method for producing a profile strip for an electrochemical energy storage device according to any one of claims 16, wherein at least one first recess is implemented in the profile strip by an appropriate method, wherein the form of said first recess is preferably made such that the profile strip can be converted from a first, straight, state into a second, angled, state, and the profile strip can be converted from a first, stretched, state into a second, angled, state, wherein the tensile strength of the profile strip in the area of the backside part is not.

28. The method according to claim 27, wherein after the bending of the profile strip in the area of the first recess, the profile strip is at least partially connected by material engagement in form of gluing or welding.

29. The method according to claim 28, wherein the bending of the profile strip in the area of the first recess, the profile strip is at least partially connected by form-fit.
